(19) United States
(12) Patent Application Publication
(10) Pub. No.: US 2011/0063210 A1
(43) Pub. Date: Mar. 17, 2011

(54) INFORMATION PROCESSING APPARATUS, DISPLAY CONTROL METHOD, AND PROGRAM

(75) Inventor: Yusuke YAMADA, Shiojiri (JP)

(73) Assignee: SEIKO EPSON CORPORATION, Tokyo (JP)

(21) Appl. No.: 12/838,780

(22) Filed: Jul. 19, 2010

(30) Foreign Application Priority Data
Sep. 17, 2009 (JP) 2009-215504

(51) Int. Cl. G06F 3/033

(52) U.S. Cl. 345/157

(57) ABSTRACT

An information processing apparatus includes an input receiving unit that receives an input of a movement operation including a movement direction and a movement distance of a pointer displayed on a display unit, and a display control unit that causes the pointer to move in accordance with the movement operation; each time the input receiving unit receives an input of the movement operation, the display control unit causes the post-movement pointer to be further displayed on the display unit in a different display form than the pre-movement pointer.

### BACKGROUND

1. Technical Field

The present invention relates to an information processing apparatus, a display control method, and a program.

2. Related Art

A display apparatus in which a location upon a display panel is specified through a user operation made on an X-axis touch sensor and a Y-axis touch sensor provided in a frame member that surrounds the edges of the display panel has been disclosed (for example, see JP-A-2007-200002).

However, with the stated technology, when the position of a pointer has moved, the user cannot be made aware of the movement path and the movement direction of the pointer.

### SUMMARY

An advantage of some aspects of the invention is to provide an information processing apparatus, a display control method, and a program capable of making a user aware of a movement path and a movement direction of a pointer with ease.

An information processing apparatus according to a first aspect of the invention includes an input receiving unit that receives an input of a movement operation including a movement direction and a movement distance of a pointer displayed on a display unit, and a display control unit that causes the pointer to move in accordance with the movement operation; each time the input receiving unit receives an input of a movement operation for moving the pointer, the display control unit causes the post-movement pointer to be further displayed on the display unit in a different display form than the pre-movement pointer.

In the aforementioned information processing apparatus, the display control unit may cause the post-movement pointer to be further displayed on the display unit in a different display form than the pre-movement pointer in accordance with a display rule by which a movement sequence of the pointer can be identified.

In the aforementioned information processing apparatus, the display form may be represented by a darkness.

In the aforementioned information processing apparatus, the display control unit may cause the darkness of the pre-movement pointer and the darkness of the post-movement pointer to differ by increasing the darkness of the pre-movement pointer.

The aforementioned information processing apparatus may further include a determination unit that determines whether or not a display screen of the display unit is to be rewritten, and the display control unit may rewrite the display screen in the case where the determination unit has determined that the display screen is to be rewritten.

In the aforementioned information processing apparatus, the display control unit may not rewrite the display screen each time the input receiving unit receives an input of the movement operation, and may rewrite the display screen in the case where the determination unit has determined that the display screen is to be rewritten.

In the aforementioned information processing apparatus, the determination unit may determine that the display screen is to be rewritten in the case where a number of times the pointer has moved has reached a predetermined number.

In the aforementioned information processing apparatus, the determination unit may determine that the display screen is to be rewritten in the case where a display time of the display screen has reached a predetermined amount of time.

Furthermore, a display control method according to a second aspect of the invention includes receiving an input of a movement operation including a movement direction and a movement distance of a pointer displayed on a display unit, and causing the pointer to move in accordance with the movement operation; each time an input of the movement operation for moving the pointer in the causing is received in the receiving, the post-movement pointer is caused to be further displayed on the display unit in a different display form than the pre-movement pointer.

Furthermore, a program according to a third aspect of the invention is a program that causes a computer to function as an input receiving unit that receives an input of a movement operation including a movement direction and a movement distance of a pointer displayed on a display unit, and a display control unit that causes the pointer to move in accordance with the movement operation; each time the input receiving unit receives an input of the movement operation for moving the pointer in the display control unit, the display control unit causes the post-movement pointer to be further displayed on the display unit in a different display form than the pre-movement pointer.

### BRIEF DESCRIPTION OF THE DRAWINGS

The invention will be described with reference to the accompanying drawings, wherein like numbers reference like elements.

FIG. 1 is a diagram illustrating an exemplary configuration of a terminal apparatus according to an embodiment of the invention.

FIG. 2 is a diagram illustrating an example of the functional configuration of a terminal apparatus.

FIG. 3 is a diagram illustrating an example of a processing procedure of a terminal apparatus.

FIGS. 4A through 4D are diagrams illustrating examples of display screens displayed on a display.

FIG. 5 is a diagram illustrating another example of a display screen displayed on a display.

FIG. 6 is a diagram illustrating an example of the hardware configuration of a terminal apparatus.

### DESCRIPTION OF EXEMPLARY EMBODIMENTS

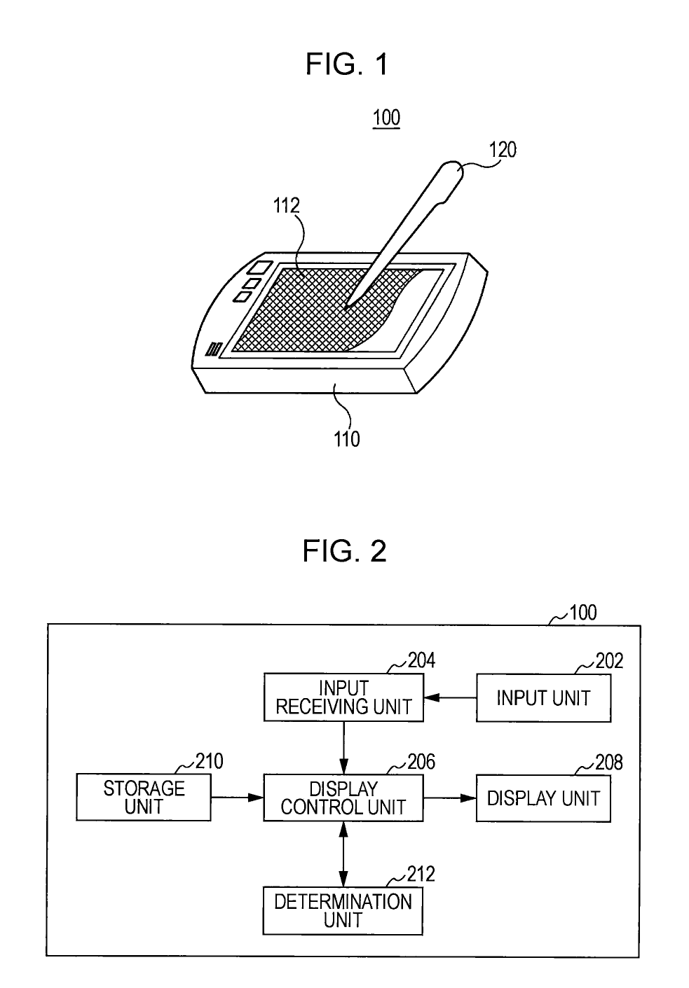

FIG. 1 is a diagram illustrating an exemplary configuration of a terminal apparatus 100 according to an embodiment of the invention. Note that in this embodiment, the terminal apparatus 100, which displays document data, will be described as an example of an information processing apparatus according to the invention. However, it should be noted that the terminal apparatus 100 may be a PDA (Personal Digital Assistant), a mobile telephone, a personal computer, or the like as well.

The terminal apparatus 100 includes a housing 110, a display 112, and a stylus pen 120. The display 112 is provided in the front surface of the housing 110. The display 112 displays document data. In addition, the display 112 displays a pointer. The pointer indicates a currently-selected position in the document data displayed in the display 112. For example, a cursor, a mouse pointer, or the like can be given as an example of the pointer. Note that in addition to the document data, the terminal apparatus 100 is also capable of displaying image data, administrative data, buttons, icons, and the like on the display 112. Electronic paper that employs an electrophoretic system is used as the display 112 of the terminal apparatus 100 according to this embodiment.

The stylus pen 120 is provided as a separate entity from the housing 110. The stylus pen 120 inputs operations into the terminal apparatus 100. The terminal apparatus 100 detects contact or pressure from the stylus pen 120 through a touch panel that is provided in the surface of the display 112, and identifies the operations inputted through the stylus pen 120 based on the location, pattern, or the like of the detected contact or pressure. The terminal apparatus 100 then carries out processing in accordance with the identified operations. For example, the terminal apparatus 100 causes the pointer displayed on the display 112 to move in accordance with a pointer movement operation inputted using the stylus pen 120. The pointer movement operation includes the movement direction and the movement distance of the pointer.

FIG. 2 is a diagram illustrating an example of the functional configuration of the terminal apparatus 100. The terminal apparatus 100 includes an input unit 202, an input receiving unit 204, a display control unit 206, a display unit 208, and a storage unit 210. The input unit 202 inputs operations into the terminal apparatus 100. The input receiving unit 204 receives the input of operations for the terminal apparatus 100 as inputted using the input unit 202. For example, the input unit 202 inputs a movement operation for the pointer that is displayed on the display unit 208. In this case, the input receiving unit 204 receives the input of the pointer movement operation as inputted using the input unit 202.

With the terminal apparatus 100 according to this embodiment, the stylus pen 120 illustrated in FIG. 1 functions as the input unit 202. The terminal apparatus 100 may include an input device such as a mouse, operational buttons, or the like instead of or in addition to the stylus pen 120. In this case, the input device may function as the input unit 202 instead of or in addition to the stylus pen 120.

The display unit 208 displays document data. In addition, the display unit 208 displays the pointer. The display control unit 206 controls the display of the display unit 208. For example, the display control unit 206 reads out the document data stored in the storage unit 210 and causes the read-out document data to be displayed on the display unit 208. In addition, the display control unit 206 causes the pointer displayed on the display unit 208 to move in accordance with the pointer movement operation whose input has been received by the input receiving unit 204. With the terminal apparatus 100 according to this embodiment, the display 112 illustrated in FIG. 1 functions as the display unit 208.

Here, the display control unit 206 according to this embodiment causes the post-movement pointer to be additionally displayed on the display unit 208 in a different display form than the pre-movement pointer each time the input of the pointer movement operation has been received by the input receiving unit 204. To be more specific, each time the input of the pointer movement operation has been received by the input receiving unit 204, the display control unit 206 causes the post-movement pointer to be additionally displayed on the display unit 208 in a different display form than the pre-movement pointer in accordance with a display rule by which the movement sequence of the pointer can be identified.

For example, each time the input of the pointer movement operation has been received by the input receiving unit 204, the display control unit 206 causes the post-movement pointer to be additionally displayed on the display unit 208 at a different darkness than the pre-movement pointer in accordance with the display rule by which the movement sequence of the pointer can be identified. The display control unit 206 may cause the darkness of the pre-movement pointer and the darkness of the post-movement pointer to differ by increasing the darkness of the pre-movement pointer each time the input of the pointer movement operation has been received by the input receiving unit 204.

The display control unit 206 may increase the darkness of the pre-movement pointer by a predetermined amount each time the input of the pointer movement operation has been received by the input receiving unit 204. As another example, the display control unit 206 may increase the darkness of the pre-movement pointer by an amount equivalent to the difference between a current value and a target value each time the input of the pointer movement operation has been received by the input receiving unit 204.

An example in which the darkness of the pre-movement pointer is increased by 25% at a time will be described hereinafter. For example, in the case where the pointer displayed in a first display position and at a darkness of 0% (the pointer in an initial state) is caused to move to a second display position, the display control unit 206 changes the darkness of the pointer displayed in the first display position to 25%, and further causes the pointer at a darkness of 0% (the pointer in the initial state) to be displayed in the second display position. Furthermore, in the case where the pointer displayed in the second display position is caused to move to a third display position, the display control unit 206 changes the darkness of the pointer displayed in the first display position to 50%, changes the darkness of the pointer displayed in the second display position to 25%, and further causes the pointer at a darkness of 0% (the pointer in the initial state) to be displayed in the third display position.

For example, in the case of the display 112, which uses electronic paper that employs an electrophoretic system, the display control unit 206 increases the darkness of the pointer by applying, to each of multiple pixels corresponding to the pointer, a predetermined voltage for increasing the darkness of the pixels for an amount of time based on the additional amount of darkness of the pointer. Note that the darkness of the pointer in the initial state may not need to be 0%. In addition, the amount by which the darkness of the pointer is increased need not be 25%.

In this manner, the terminal apparatus 100 according to this embodiment displays multiple pointers at differing darknesses upon the movement path of the pointer in accordance with the movement of the pointer, and it is thus possible to make the user of the terminal apparatus 100 aware of the movement path and the movement direction of the pointer with ease. Note that the display control unit 206 may cause the darkness of the pre-movement pointer and the darkness of the post-movement pointer to differ by reducing the darkness of the pre-movement pointer. In addition, the display control unit 206 may cause the transparency, color, shape, size, or the like of the pre-movement pointer and the post-movement pointer to differ in accordance with the display rule by which the movement sequence of the pointer can be identified.

The terminal apparatus 100 according to this embodiment further includes a determination unit 212. The determination unit 212 determines whether or not to rewrite the display screen of the display unit 208. For example, the determination unit 212 determines to rewrite the display screen of the display unit 208 in the case where the number of pointer movements has reached a predetermined number. The determination unit 212 may determine to rewrite the display screen of the display unit 208 in the case where the display time of the display screen on the display unit 208 has reached a predetermined amount of time. The display control unit 206 may rewrite the display screen of the display unit 208 in the case where the determination unit 212 has determined to rewrite the display screen of the display unit 208, rather than rewriting the display screen of the display unit 208 each time the input receiving unit 204 has received an input of a movement instruction.

The display control unit 206 rewrites the display screen of the display unit 208 by newly displaying, on the display unit 208, a display screen that reflects the latest display content, after first initializing the display screen of the display unit 208. For example, in the case of the display 112, which uses electronic paper that employs an electrophoretic system, the display control unit 206 initializes the display screen of the display unit 208 by reducing the darkness of each of the multiple pixels provided in the display unit 208 through the application, to each of those pixels, of a predetermined voltage for decreasing the darkness of the pixels for an amount of time based on the reduction amount of darkness of those pixels.

In the case where the display screen of the display unit 208 has been rewritten, the display control unit 206 may display the pointer indicating the latest selected position in the post-rewrite display screen without displaying the pre-movement pointer, which had been displayed in the pre-rewrite display screen, in the post-rewrite display screen. In addition, the display control unit 206 may determine whether or not to rewrite the display screen of the display unit 208 based on a condition aside from that stated above. For example, the display control unit 206 may determine to rewrite the display screen of the display unit 208 in the case where the darkness of any of the pointers displayed in the display screen of the display unit 208 has reached a predetermined darkness (for example, 100%).

In addition, the display control unit 206 may rewrite the entirety of the display screen, or may rewrite only part of the display screen. For example, in the case where the display screen contains multiple regions, the terminal apparatus 100 may rewrite, of those multiple regions, the region in which the pointer is displayed. Note that the timing at which the calculation of the display time of the display screen is commenced is not limited to the timing at which the display screen is displayed; for example, the timing at which the pointer movement operation stops may be used instead.

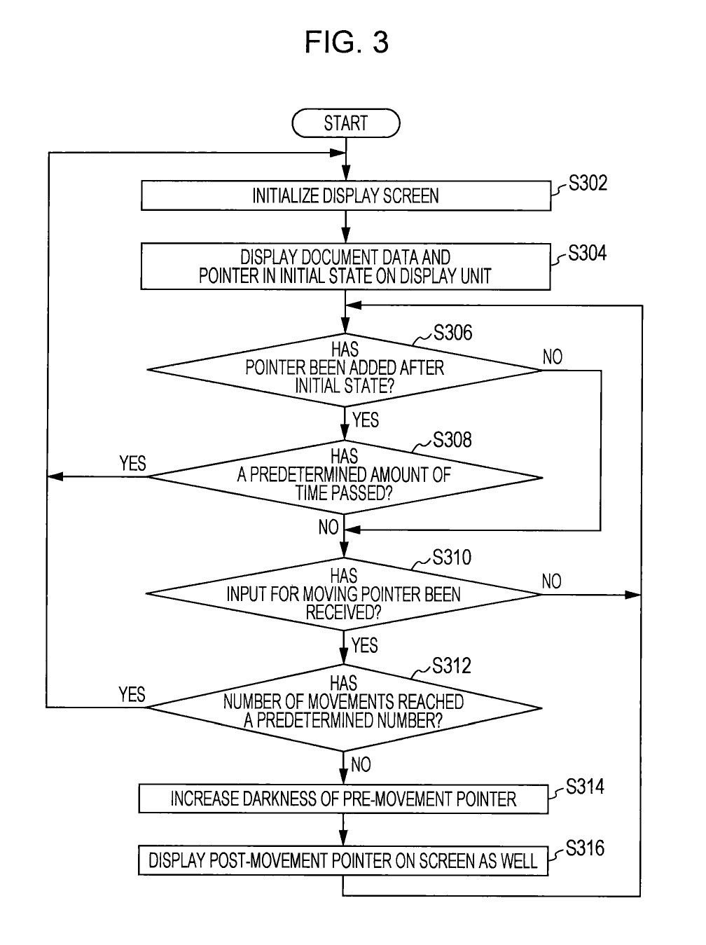

FIG. 3 is a diagram illustrating an example of a processing procedure of the terminal apparatus 100. First, the display control unit 206 initializes the display screen of the display unit 208 (step S302). Next, the display control unit 206 causes the document data and the pointer in the initial state to be displayed on the display unit 208 (step S304).

Next, the display control unit 206 determines whether or not the pointer has been rewritten from the initial state of the display screen (step S306). In the case where the display control unit 206 has determined in step S306 that the pointer has been rewritten from the initial state of the display screen (step S306: Yes), the terminal apparatus 100 advances the processing to step S308. However, in the case where the display control unit 206 has determined in step S306 that the pointer has not been rewritten from the initial state of the display screen (step S306: No), the terminal apparatus 100 advances the processing to step S310.

In step S308, the determination unit 212 determines whether or not a predetermined amount of time has elapsed since the document data and the pointer were displayed in step S304 (step S308). In the case where the determination unit 212 has determined in step S308 that the predetermined amount of time has elapsed since the document data and the pointer were displayed in step S304 (step S308: Yes), the terminal apparatus 100 returns the processing to step S302. However, in the case where the determination unit 212 has determined in step S308 that the predetermined amount of time has not elapsed since the document data and the pointer were displayed in step S304 (step S308: No), the terminal apparatus 100 advances the processing to step S310.

In step S310, the display control unit 206 determines whether or not a pointer movement operation input has been received by the input receiving unit 204 (step S310). In the case where it has been determined in step S310 that a pointer movement operation input has not been received by the input receiving unit 204 (step S310: No), the terminal apparatus 100 returns the processing to step S306. However, in the case where it has been determined in step S310 that a pointer movement operation input has been received by the input receiving unit 204 (step S310: Yes), the terminal apparatus 100 advances the processing to step S312.

In step S312, the determination unit 212 determines whether or not the number of pointer movements has reached a predetermined number (step S312). In the case where the determination unit 212 has determined in step S312 that the number of pointer movements has reached the predetermined number (step S312: Yes), the terminal apparatus 100 returns the processing to step S302. On the other hand, in the case where the determination unit 212 has determined in step S312 that the number of pointer movements has not reached the predetermined number (step S312: No), the display control unit 206 increases the darkness of the pre-movement pointer displayed on the display unit 208 (step S314), and the display control unit 206 additionally displays the post-movement pointer indicating the latest selected position on the display unit 208 (step S316). The terminal apparatus 100 then returns the processing to step S306.

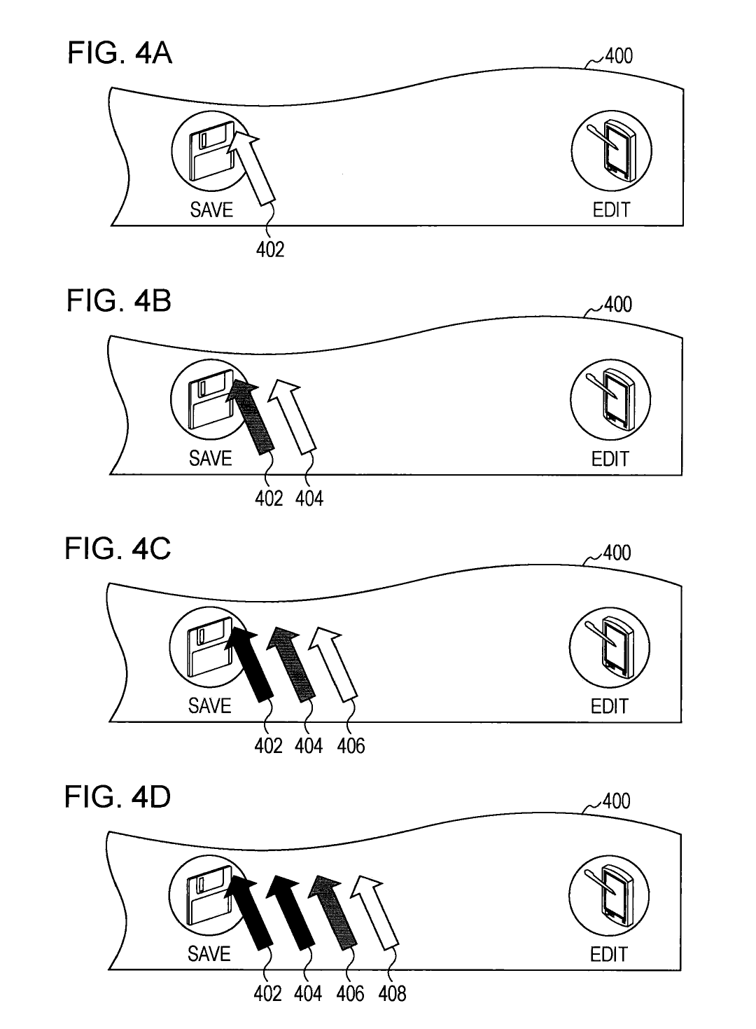

FIGS. 4A through 4D are diagrams illustrating examples of the display screens displayed on the display 112. A screen 400 illustrated in FIG. 4A is a display screen displayed on the display 112, and indicates the display screen prior to the pointer moving from an initial position. A pointer 402 is indicated in the screen 400 illustrated in FIG. 4A. The darkness of the pointer 402 in the screen 400 illustrated in FIG. 4A is 0%. As a result, in the screen 400 illustrated in FIG. 4A, the display position of the pointer 402 indicates the current position of the pointer. Meanwhile, only a single pointer is displayed in the screen 400 illustrated in FIG. 4A. As a result, in the screen 400 illustrated in FIG. 4A, the display position of the pointer 402 indicates the initial position of the pointer.

The screen 400 illustrated in FIG. 4B indicates the state of the display screen displayed on the display 112 as a result of the pointer being moved from the state displayed in the screen 400 illustrated in FIG. 4A. The pointer 402 and a pointer 404 are indicated in the screen 400 illustrated in FIG. 4B. In the screen 400 illustrated in FIG. 4B, the darkness of the pointer 402 is 33%, whereas the darkness of the pointer 404 is 0%. As a result, the screen 400 illustrated in FIG. 4B indicates that the pointer has moved from the display position of the pointer 402 to the display position of the pointer 404, and that the display position of the pointer 404 is the current position of the pointer.

The screen 400 illustrated in FIG. 4C indicates the state of the display screen displayed on the display 112 as a result of the pointer being further moved from the state displayed in the screen 400 illustrated in FIG. 4B. The pointer 402, the pointer 404, and a pointer 406 are indicated in the screen 400 illustrated in FIG. 4C. In the screen 400 illustrated in FIG. 4C, the darkness of the pointer 402 is 66%, the darkness of the pointer 404 is 33%, and the darkness of the pointer 406 is 0%. As a result, the screen 400 illustrated in FIG. 4C indicates that the pointer has moved from the display position of the pointer 402 to the display position of the pointer 406 via the display position of the pointer 404, and that the display position of the pointer 406 is the current position of the pointer.

The screen 400 illustrated in FIG. 4D indicates the state of the display screen displayed on the display 112 as a result of the pointer being further moved from the state displayed in the screen 400 illustrated in FIG. 4C. The pointer 402, the pointer 404, the pointer 406, and a pointer 408 are indicated in the screen 400 illustrated in FIG. 4D. In the screen 400 illustrated in FIG. 4D, the darkness of the pointer 402 is 100%, the darkness of the pointer 404 is 66%, the darkness of the pointer 406 is 33%, and the darkness of the pointer 408 is 0%. As a result, the screen 400 illustrated in FIG. 4D indicates that the pointer has moved from the display position of the pointer 402 to the display position of the pointer 408 via the display position of the pointer 404 and the display position of the pointer 406, and that the display position of the pointer 408 is the current position of the pointer.

In this manner, according to the terminal apparatus 100 of this embodiment, multiple pointers are displayed at differing darknesses upon the movement path of the pointer in accordance with the movement of the pointer, and it is thus possible to make the user of the terminal apparatus 100 aware not only of the current position of the pointer, but also of the movement path and the movement direction of the pointer with ease.

Note that the terminal apparatus 100 may display a pointer that has undergone bordering processing, or may display a pointer that has not undergone bordering processing. In addition, the terminal apparatus 100 may display the pointer in a transparent manner so that the user can be aware of the information present behind the pointer, or may display the pointer in a non-transparent manner so that the user cannot be aware of the information present behind the pointer.

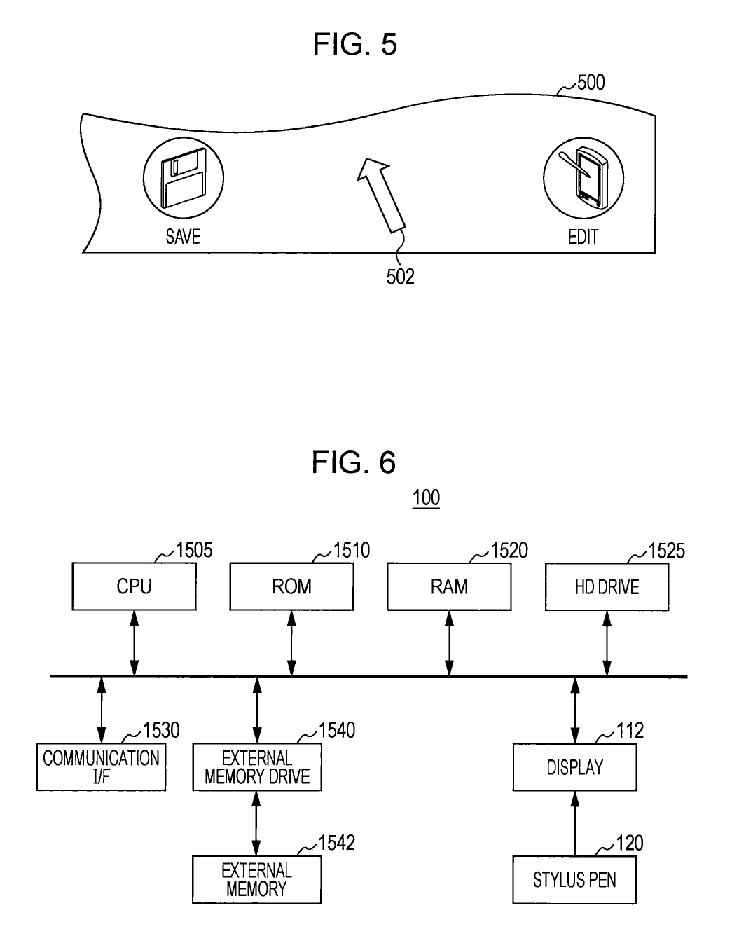

FIG. 5 is a diagram illustrating another example of a display screen displayed on the display 112. A screen 500 illustrated in FIG. 5 indicates a display screen displayed on the display 112 as a result of the pointer being further moved from the state displayed in the screen 400 illustrated in FIG. 4D. To be more specific, the pointer has been moved from the state displayed in the screen 400 illustrated in FIG. 4D and from the position of the pointer 408 illustrated in FIG. 4D to the position of a pointer 502 indicated in FIG. 5. Through this, the number of pointer movements has reached a predetermined number of four. Accordingly, the terminal apparatus 100 initializes the screen 400 displayed on the display 112, and newly displays the screen 500 on the display 112.

The darkness of the pointer 502 in the screen 500 is 0%. As a result, in the screen 500, the display position of the pointer 502 indicates the current position of the pointer. In addition, only a single pointer is displayed in the screen 500. As a result, in the screen 500, the display position of the pointer 502 indicates the initial position of the pointer after the screen 400 has been initialized.

Note that before the number of pointer movements reaches the predetermined number, the terminal apparatus 100 initializes the screen 400 and newly displays the screen 500 on the display 112, in the same manner as the case where the display time of the screen 400 has reached a predetermined amount of time. Meanwhile, in the case where the pointer is further moved from the state in which the screen 500 is displayed on the display 112, the terminal apparatus 100 displays multiple pointers at differing darknesses upon the movement path of the pointer in accordance with the movement of the pointer, in the same manner as illustrated in FIGS. 4A through 4D. Furthermore, in the case where the number of pointer movements has further reached the predetermined number or the case where the display time of the screen 500 has reached the predetermined amount of time after the screen 500 has been displayed on the display 112, the screen 500 is initialized and a display screen indicating the latest display content is newly displayed, in the same manner as the processing illustrated in FIG. 5.

In this manner, according to the terminal apparatus 100 of this embodiment, the display screen is rewritten in the case where a predetermined rewriting condition has been met, rather than rewriting the display screen each time the pointer moves; as a result, the latest display screen indicating the current position of the pointer can be displayed in a short amount of time. Furthermore, according to the terminal apparatus 100 of this embodiment, the darkness of the pointer is changed by increasing the darkness of the pointer from the current value by a predetermined amount or to a target value; the processing for changing the darkness of the pointer can be carried out in a shorter amount of time than newly displaying the pointer at the post-change darkness. As a result, the latest display screen indicating the current position of the pointer can be displayed in a short amount of time, thus allowing the user to view the document data without causing him/her to feel any stress.

The information processing apparatus, the display control method, and the program according to the invention can be applied in various information processing apparatuses that include a display unit that displays a pointer. In particular, it takes time to rewrite the display screen in an information processing apparatus that uses electronic paper employing an electrophoretic system as the display 112, such as the terminal apparatus 100 of this embodiment. Accordingly, applying the information processing apparatus, the display control method, and the program according to the invention in such an information processing apparatus makes it possible to reduce the amount of time involved in displaying the display screen more than an information processing apparatus that displays a pointer using another display technique.

FIG. 6 is a diagram illustrating an example of the hardware configuration of the terminal apparatus 100. In addition to the display 112 and the stylus pen 120 illustrated in FIG. 1, the terminal apparatus 100 further includes a CPU 1505, a ROM 1510, a RAM 1520, an HD (hard disk) drive 1525, a communication interface 1530, an external memory drive 1540, and an external memory 1542.

The ROM 1510, the RAM 1520, and the HD drive 1525 store various types of data and various types of programs. At least one of the ROM 1510, the RAM 1520, and the HD drive 1525 functions as the storage unit 210 described with reference to FIGS. 1 through 5.

The CPU 1505 performs various types of data processing and various types of hardware control by executing programs stored in the ROM 1510, the RAM 1520, and the HD drive 1525. The programs executed by the CPU 1505 cause a computer to function as the input receiving unit 204, the display control unit 206, and the determination unit 212 described with reference to FIGS. 1 through 5.

The communication interface 1530 connects to a communication network and exchanges data with an external device via the communication network. The external memory drive 1540 connects to the external memory 1542 and exchanges data with the external memory 1542. A memory card can be given as an example of the external memory 1542. The external memory 1542 may, however, be a recording medium such as a flexible disk, a CD, a DVD, or the like. The external memory 1542 may function as the storage unit 210 described with reference to FIGS. 1 through 5.

The programs executed by the CPU 1505 may be stored, for example, in the external memory 1542 as described above, or may be provided to the terminal apparatus 100 from the external memory 1542. In addition, the programs executed by the CPU 1505 may be stored in a recording medium such as a memory, a hard disk, or the like provided in the external device, or may be provided to the terminal apparatus 100 from the external device via the communication network.

The entire disclosure of Japanese Patent Application No. 2009-215504, filed Sep. 17, 2009 is expressly incorporated by reference herein.

What is claimed is:

1. An information processing apparatus comprising:
an input receiving unit that receives an input of a movement operation including a movement direction and a movement distance of a pointer displayed on a display unit; and
a display control unit that causes the pointer to move in accordance with the movement operation,
wherein each time the input receiving unit receives an input of the movement operation, the display control unit causes the post-movement pointer to be further displayed on the display unit in a different display form than the pre-movement pointer.

2. The information processing apparatus according to claim 1,
wherein the display control unit causes the post-movement pointer to be further displayed on the display unit in a different display form than the pre-movement pointer in accordance with a display rule by which a movement sequence of the pointer can be identified.

3. The information processing apparatus according to claim 2,
wherein the display form is represented by a darkness.

4. The information processing apparatus according to claim 3,
wherein the display control unit causes the darkness of the pre-movement pointer and the darkness of the post-movement pointer to differ by increasing the darkness of the pre-movement pointer.

5. The information processing apparatus according to claim 1, further comprising:
a determination unit that determines whether or not a display screen of the display unit is to be rewritten,
wherein the display control unit rewrites the display screen in the case where the determination unit has determined that the display screen is to be rewritten.

6. The information processing apparatus according to claim 5,
wherein the display control unit does not rewrite the display screen each time the input receiving unit receives an input of the movement operation, and rewrites the display screen in the case where the determination unit has determined that the display screen is to be rewritten.

7. The information processing apparatus according to claim 5,
wherein the determination unit determines that the display screen is to be rewritten in the case where a number of times the pointer has moved has reached a predetermined number.

8. The information processing apparatus according to claim 5,
wherein the determination unit determines that the display screen is to be rewritten in the case where a display time of the display screen has reached a predetermined amount of time.

9. A display control method comprising:
receiving an input of a movement operation including a movement direction and a movement distance of a pointer displayed in a display unit; and
causing the pointer to move in accordance with the movement operation,
wherein each time an input of the movement operation for moving the pointer is received, the post-movement pointer is caused to be further displayed on the display unit in a different display form than the pre-movement pointer.

10. A program that causes a computer to function as:
an input receiving unit that receives an input of a movement operation including a movement direction and a movement distance of a pointer displayed on a display unit; and
a display control unit that causes the pointer to move in accordance with the movement operation,
wherein each time the input receiving unit receives an input of the movement operation for moving the pointer, the display control unit causes the post-movement pointer to be further displayed on the display unit in a different display form than the pre-movement pointer.
